(19) United States
(12) Patent Application Publication
(10) Pub. No.: US 2010/0159297 A1
(43) Pub. Date: Jun. 24, 2010

(54) HYDROCARBON REFORMING CATALYST, METHOD OF PREPARING THE HYDROCARBON REFORMING CATALYST, AND FUEL CELL EMPLOYING THE HYDROCARBON REFORMING CATALYST

(75) Inventors: Doo-hwan LEE, Suwon-si (KR); Hyun-chul Lee, Hwaseong-si (KR); Eun-duck Park, Seoul (KR); Kang-hee Lee, Suwon-si (KR); Yun-ha Kim, Jeju-si (KR); Jae-hyun Park, Daeju (KR)

Correspondence Address: STEIN MCEWEN, LLP, 1400 EYE STREET, NW, SUITE 300, WASHINGTON, DC, 20005, US

(73) Assignees: SAMSUNG ELECTRONICS CO., LTD., Suwon-si (KR); SAMSUNG SDI CO., LTD., Suwon-si (KR)

(21) Appl. No.: 12/577,918

(22) Filed: Oct. 13, 2009

(30) Foreign Application Priority Data
Dec. 22, 2008 (KR) 10-2008-0131200

(51) Int. Cl. H01M 8/18; B01J 21/06; B01J 23/10; B01J 23/755; B01J 23/88; B01J 23/34; B01J 23/00

(52) U.S. Cl. 429/19; 502/259; 502/304; 502/315; 502/324; 502/326; 502/335; 502/337

(57) ABSTRACT

A hydrocarbon reforming catalyst, a method of preparing the hydrocarbon reforming catalyst, and a fuel cell including the hydrocarbon reforming catalyst. The hydrocarbon reforming catalyst includes a nickel active catalyst layer loaded on an oxide carrier, and a metal oxide.

### CROSS-REFERENCE TO RELATED APPLICATION

This application claims the benefit of Korean Patent Application No. 10-2008-0131200, filed on Dec. 22, 2008, in the Korean Intellectual Property Office, the disclosure of which is incorporated herein, by reference.

### BACKGROUND

1. Field

The present teachings relate to a hydrocarbon reforming catalyst, a method of preparing the hydrocarbon reforming catalyst, and a fuel cell employing the hydrocarbon reforming catalyst.

2. Description of the Related Art

Recently, new environmentally friendly energy technologies have come into the spotlight. In particular, fuel cells are gaining attention as one such environmentally friendly energy technology. A fuel cell converts chemical energy into electric energy, by electrochemically reacting hydrogen and oxygen. A fuel cell has a high energy efficiency, and studies regarding the practical use of fuel cells in consumer, industrial, and vehicular applications are actively being performed.

Methanol, liquefied natural gas mainly including methane, city gas having the liquefied natural gas as the main component, synthesized liquid fuel having natural gas as a raw material, and petroleum-based hydrocarbons, such as naphtha or kerosene, are being studied as hydrogen sources for fuel cells.

When hydrogen is prepared by using a petroleum-based hydrocarbon, a steam reforming reaction using a catalyst is performed on the petroleum-based hydrocarbon. Here, a conventional carrier containing a ruthenium active component has been studied for use as the catalyst for the steam reforming reaction. Also, catalysts based on cerium oxide, or zirconium oxide, and ruthenium are being studied, since a promoter effect has been discovered for such catalysts. Besides ruthenium, studies regarding catalysts including platinum, rhodium, palladium, iridium, or nickel, as an active component, are also performed.

### SUMMARY

The present teachings relate to a hydrocarbon reforming catalyst.

The present teachings relate to a method of preparing the hydrocarbon reforming catalyst.

The present teachings relate to a fuel cell employing the hydrocarbon reforming catalyst.

One or more embodiments of the present teachings relate to a hydrocarbon reforming catalyst including: a nickel active catalyst layer and a metal oxide, supported on an oxide carrier. The metal oxide may be at least one of a manganese oxide, a tin oxide, a cerium oxide, a rhenium oxide, a molybdenum oxide, and a tungsten oxide. The oxide carrier may be formed of at least one oxide of Al₂O₃, SiO₂, ZrO₂, TiO₂, and yttria-stabilized zirconia (YSZ).

According to various embodiments, the metal oxide may be distributed on and/or in the nickel active catalyst layer.

According to various embodiments, the amount of nickel may be from about 1.0 to 40 parts by weight, based on 100 parts by weight of the hydrocarbon reforming catalyst.

According to various embodiments, the amount of metal in the metal oxide may be from about 0.5 to 20 parts by weight, based on 1 part by weight of nickel.

Various embodiments of the present teachings relate to a method of preparing a hydrocarbon reforming catalyst, the method including: loading nickel on an oxide carrier; heat-treating the nickel-loaded oxide carrier; loading a metal oxide precursor on the heat-treated nickel-loaded oxide carrier; and heat-treating the resultant.

To achieve the above and/or other aspects, one or more embodiments may include a method of preparing a hydrocarbon reforming catalyst, the method including: loading a metal oxide precursor on an oxide carrier; heat-treating the precursor-loaded oxide carrier; loading nickel on the heat-treated precursor-loaded oxide carrier; and heat-treating the resultant.

Various embodiments of the present teachings relate to a method of preparing a hydrocarbon reforming catalyst, the method including simultaneously loading a metal oxide precursor and nickel on an oxide carrier, and heat-treating the resultant.

According to various embodiments, the loading of the nickel and the loading of the metal oxide precursor may be performed using deposition precipitation, co-precipitation, wet impregnation, sputtering, gas-phase grafting, liquid-phase grafting, or incipient-wetness impregnation.

According to various embodiments, the heat-treating may be performed for from about 2 to 5 hours, at from about 500 to 750° C.

To achieve the above and/or other aspects, one or more exemplary embodiments may include a fuel cell including the hydrocarbon reforming catalyst.

Additional aspects and/or advantages of the present teachings will be set forth in part in the description which follows and, in part, will be obvious from the description, or may be learned by practice of the invention.

### BRIEF DESCRIPTION OF THE DRAWINGS

These and/or other aspects and advantages of the present teachings will become apparent and more readily appreciated from the following description of the exemplary embodiments, taken in conjunction with the accompanying drawings, of which:

FIG. 1 is a diagram schematically illustrating a structure of a hydrocarbon reforming catalyst, according to an exemplary embodiment;

FIGS. 2 through 4 are diagrams for describing methods of preparing a hydrocarbon reforming catalyst, according to exemplary embodiments; and

FIGS. 5 through 8 are graphs showing results of evaluating the performance of hydrocarbon reforming catalysts obtained according to Examples 1 and 2, and Comparative Example 1.

### DETAILED DESCRIPTION OF THE EXEMPLARY EMBODIMENTS

Reference will now be made in detail to the exemplary embodiments of the present teachings, examples of which are illustrated in the accompanying drawings, wherein like reference numerals refer to the like elements throughout. The exemplary embodiments are described below, in order to explain the aspects of the present teachings, by referring to the figures.

Herein, when a first element is referred to as being “loaded on” or “supported by” a second element, the first element can be dispersed on the surface of the element and/or may be dispersed in the second element. Herein, when a first element is referred to as being formed or disposed “on” a second element, the first element can be disposed directly on the second element, or one or more other elements may be disposed therebetween. When a first element is referred to as being formed or disposed “directly on” a second element, no other elements are disposed therebetween.

In order to generate hydrogen fuel for a fuel cell system, a hydrocarbon reforming catalyst accelerates a steam reforming (SR) reaction, wherein the hydrocarbon is reacted with steam at a high temperature, according to Reaction Formula 1, below.

CₙHₘ+nH₂O→nCO+(n+m/2)H₂ Reaction Formula 1

The amount of CO gas in the reformate generated according to Reaction Formula 1 is minimized, via a water gas shift reaction, wherein the CO gas reacts with steam at a temperature of from about 200 to 400° C. and is converted into carbon dioxide and hydrogen, as shown in Reaction Formula 2, below.

CO+H₂O→CO₂+H₂ Reaction Formula 2

Such a reforming reaction progresses catalytically at temperatures of from about 600 to 900° C. Therefore, a relatively high reforming reaction rate (i.e. a catalytic activity), coking resistance (i.e. carbon deposition suppression), and high temperature thermal stability (i.e. durability), are generally sought after in a reforming catalyst for the reforming reaction.

In a hydrocarbon reforming catalyst, according to an exemplary embodiment of the present teachings, nickel as an active catalyst and a metal oxide as a co-catalyst are supported on an oxide carrier. The hydrocarbon reforming catalyst exhibits excellent catalytic activity. Also, a high coking resistance and long-term thermal stability of the hydrocarbon reforming catalyst are obtained, by using the metal oxide.

The oxide carrier may be a conventional oxide carrier used in a reforming catalyst. The oxide carrier may have a porous structure having a high surface area. The oxide carrier may be formed of at least one oxide selected from among Al₂O₃, SiO₂, ZrO₂, TiO₂, and yttria-stabilized zirconia (YSZ).

The hydrocarbon reforming catalyst includes a nickel layer as an active component. Nickel has an excellent catalytic activity and a low price, as compared to ruthenium, platinum, rhodium, palladium, and iridium, which are used as conventional active components of a reforming catalyst. The amount of nickel may be from about 1.0 to 40 parts by weight, based on 100 parts by weight of the hydrocarbon reforming catalyst. The nickel can be formed as a continuous or discontinuous layer on the oxide carrier.

The hydrocarbon reforming catalyst may include at least one metal oxide co-catalyst selected from among a manganese oxide, a tin oxide, a cerium oxide, a rhenium oxide, a molybdenum oxide, and a tungsten oxide. When a saturated hydrocarbon, or an unsaturated hydrocarbon having a high carbon number, is used in a fuel cell system, carbon may be significantly deposited during a reforming reaction, thereby causing a reduction in the performance of the hydrocarbon reforming catalyst. When carbon is excessively accumulated in a reactor, the pressure in the reactor increases, and thus, it is difficult to continue the reforming reaction. The present hydrocarbon reforming catalysts include the metal oxide, thereby preventing the deposition of carbon. The amount of the metal in the metal oxide may be from about 0.5 to 20 parts by weight, based on 1 part by weight of nickel.

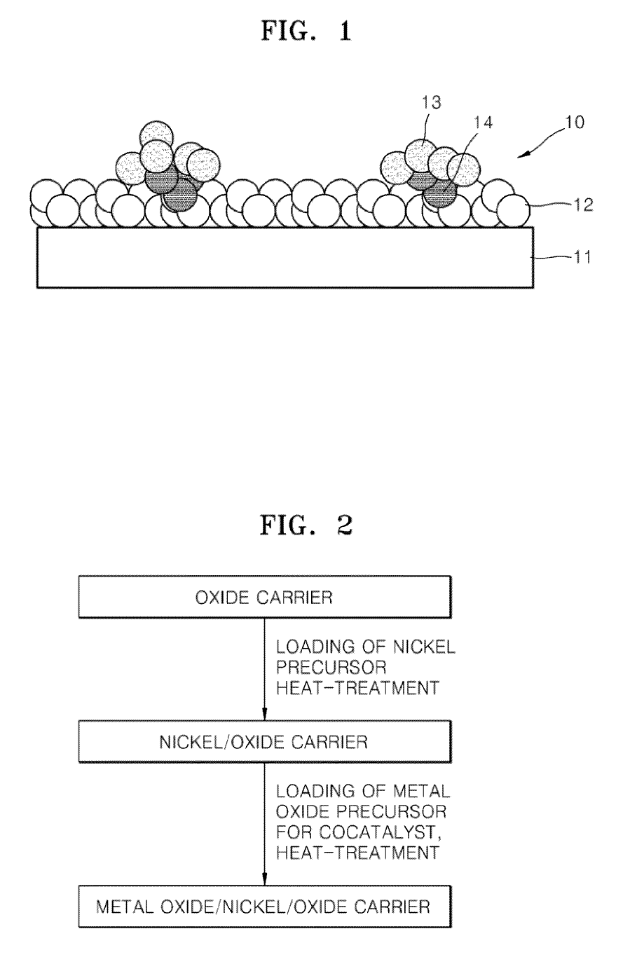

The metal oxide may be distributed on the surface of and/or within a nickel active catalyst layer. FIG. 1 is a diagram schematically illustrating the structure of a hydrocarbon reforming catalyst 10, according to an exemplary embodiment of the present teachings.

Referring to FIG. 1, the hydrocarbon reforming catalyst 10 includes an oxide carrier 11, a nickel active catalyst layer 12, and a metal oxide 13. The nickel active catalyst layer 12 is supported on the oxide carrier 11, and the metal oxide 13 is distributed on the nickel active catalyst layer 12. Although not limited in theory, a coking site 14, where carbon is deposited during a reforming reaction, may be formed on the surface of the nickel active catalyst layer 12. The activity of the hydrocarbon reforming catalyst 10 may be improved, if the metal oxide 13 blocks the coking site 14.

A hydrocarbon reforming catalyst, according to another exemplary embodiment of the present teachings, has a nickel active catalyst and metal oxide co-catalyst that are structurally mixed and supported on an oxide carrier. The metal oxide may exist on the surface of and/or within a layer of the nickel, according to some exemplary embodiments. Although not limited in theory, the mixture of the metal oxide and the nickel may suppress the formation of a coking site in the nickel active catalyst.

A method of preparing a hydrocarbon reforming catalyst, according to exemplary embodiments of the present teachings, will now be described. As illustrated in FIGS. 2 through 4, a hydrocarbon reforming catalyst may be prepared, by simultaneously loading a nickel precursor and a metal oxide precursor on an oxide carrier. Alternatively, the nickel precursor and the metal oxide precursor may be sequentially loaded, in that order.

Referring to FIG. 2, the method includes: loading the nickel precursor on an oxide carrier; heat-treating the nickel precursor-loaded oxide carrier, to form a nickel active catalyst layer; loading a metal oxide precursor on the nickel active catalyst layer; and heat-treating the resultant.

Any one of various well known methods may be used to load the nickel precursor and the metal oxide precursor on the oxide carrier. For example, methods such as deposition precipitation, co-precipitation, wet impregnation, sputtering, gas-phase grafting, liquid-phase grafting, and incipient-wetness impregnation may be used. When a loading method that does not use a liquid medium is used, a drying process as described below may be omitted.

For example, when the nickel precursor is loaded via wet impregnation, a mixed solution is prepared by adding and uniformly mixing a nickel precursor solution and an oxide carrier. As described above, the oxide carrier may be selected from among Al₂O₃, SiO₂, ZrO₂, TiO₂, and YSZ. The nickel precursor solution may be prepared by dissolving a nickel salt in a solvent, such as water; an alcohol-based solvent such as methanol, ethanol, isopropyl alcohol, or butyl alcohol; or a mixture thereof. The conditions for mixing the nickel precursor solution and the oxide carrier are not specifically limited. For example, the nickel precursor solution and the oxide carrier may be stirred for from about 1 to 12 hours, at from about 40 to 80° C. The nickel salt may be a nickel halide, including chloride or fluoride, a nickel nitrate, a nickel sulfate, a nickel acetate, or a mixture thereof.

The mixed solution is dried, for example, for from about 3 to 5 hours, at 100 to 160° C. The dried mixed solution is then heat-treated to obtain a heat-treated product. For example, the heat-treated product, where nickel is loaded on the oxide carrier, may be obtained by heat-treating the dried mixed solution for from about 2 to 5 hours, at from about 500 to 750° C. The heat-treatment may be performed in an oxidation atmosphere, for example, in an air atmosphere.

Next, the metal oxide precursor is loaded on the heat-treated product, according to the same method used for loading the nickel precursor. For example, when wet impregnation is used, a metal oxide precursor solution may be prepared by dissolving: a metallic salt in the above described solvent. The metal oxide precursor solution is uniformly mixed with an oxide carrier. The metal salt may include a halide, such as a chloride or fluoride, a nitrate, a sulfate, or an acetate, of at least one metal selected from among manganese, tin, cerium, molybdenum, and tungsten.

Then, by performing the drying and heat-treating processes as described above, the metal oxide precursor is oxidized into a metal oxide. Accordingly, the hydrocarbon reforming catalyst 10 of FIG. 1 is formed.

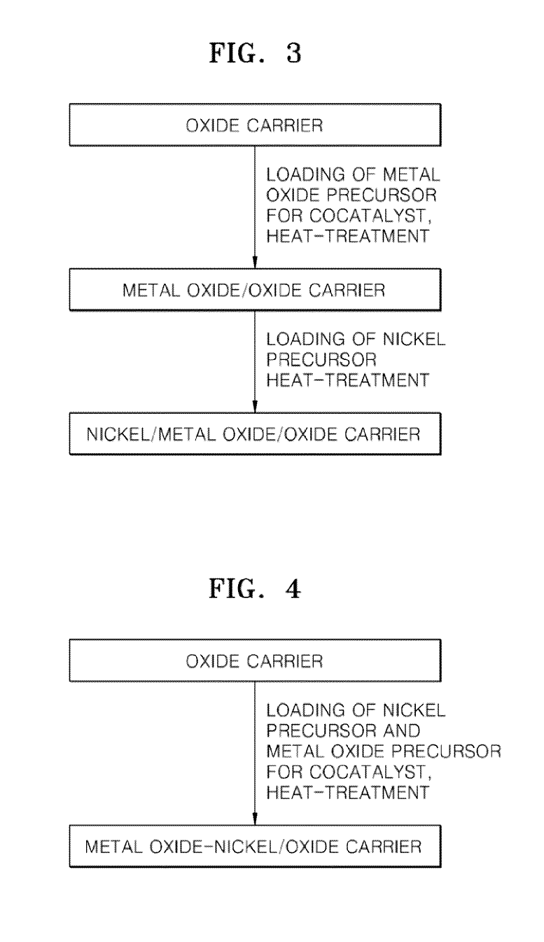

Referring to FIG. 3, the method according to another exemplary embodiment includes: loading a metal oxide precursor on an oxide carrier; heat-treating the precursor-loaded oxide carrier, to form a metal oxide-loaded carrier; loading nickel on the metal oxide-loaded carrier; and heat-treating the resultant. The method of FIG. 3 is performed in the same manner as the method of FIG. 2, except that the metal oxide and the nickel are sequentially loaded on the oxide carrier, in that order. Accordingly, a hydrocarbon reforming catalyst including a nickel/metal oxide/oxide carrier may be obtained.

Referring to FIG. 4, the method includes simultaneously loading a nickel precursor and a metal oxide precursor on an oxide carrier, and heat-treating the resultant. When the nickel and the metal oxide precursors are simultaneously loaded, via, for example, wet impregnation, an oxide carrier is uniformly mixed with a solution including both the nickel precursor and the metal oxide precursor, and then the resultant is dried. The nickel precursor, the metal oxide precursor, and the solvent are as described above.

In some aspects, an additional amount of the metal oxide precursor or the metal oxide may be loaded on the hydrocarbon reforming catalyst. The hydrocarbon reforming catalyst may be processed for from about 1 to 2 hours, at 600 to 950° C., in a hydrogen atmosphere, before being used for a reforming reaction.

According to another exemplary embodiment, a fuel processing apparatus including the hydrocarbon reforming catalyst is provided. The fuel processing apparatus may be obtained by manufacturing a reforming apparatus including the hydrocarbon reforming catalyst, and then manufacturing the fuel processing apparatus including the reforming apparatus. The hydrocarbon reforming catalyst may be fixed to a tubular reactor or a mixed flow reactor, but the present teachings are not limited thereto.

The exemplary embodiments will be described in greater detail with reference to the following examples. The following examples are for illustrative purposes only and are not intended to limit the scope of the present teachings.

<Preparation of Catalyst>

### Example 1

30.4 g of an Ni(NO₃)₂.H₂O (Aldrich) nickel precursor was impregnated into 100 g of an Al₂O₃ carrier (Alfa, particle size: 100 μm, surface area: 150 m²g⁻¹), so that the amount of Ni in a final catalyst was 5 wt %. The mixture thereof was dried for 24 hours at 110° C., and then was calcined for 2 hours, at 700° C., in an air atmosphere.

Then, 46.77 g of an Mn(NO₃)₂.H₂O manganese oxide precursor was impregnated into the resultant calcined product, such that a weight ratio of Mn/Ni was 1:1. The mixture thereof was dried for 24 hours at 110° C. and then calcined for 2 hours at 700° C., so as to obtain an MnOₓ/Ni/Al₂O₃ hydrocarbon reforming catalyst.

### Example 2

An Ni-MnOₓ/Al₂O₃ hydrocarbon reforming catalyst was obtained according to the same manner as Example 1, except that the nickel precursor and the manganese oxide precursor were simultaneously impregnated into the Al₂O₃ carrier.

### Comparative Example 1

An Ni/Al₂O₃ hydrocarbon reforming catalyst was obtained in the same manner as Example 1, except that the impregnation of the manganese precursor and the associated operations were omitted.

<Performance Evaluation of Catalyst>

### Evaluation Example 1

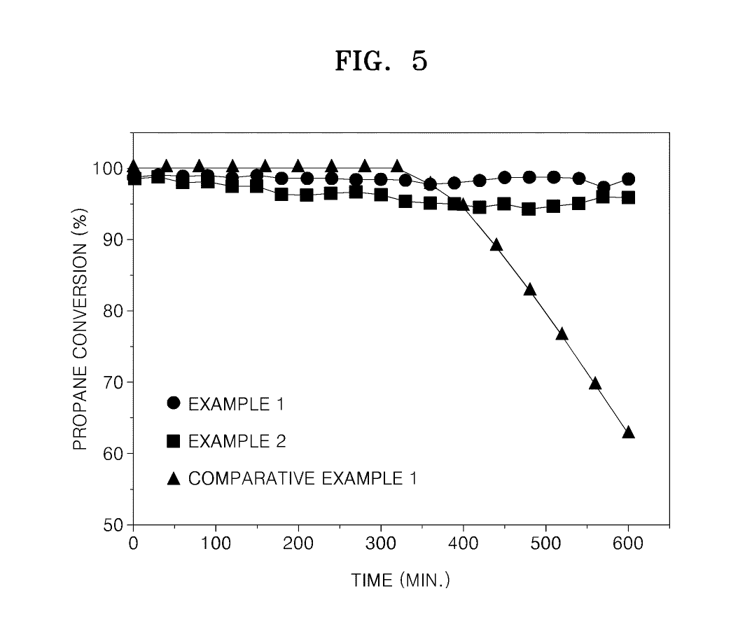

Propane conversions over the hydrocarbon reforming catalysts prepared in Examples 1 and 2, and Comparative Example 1 were measured over time, under the following operation conditions, and the results are shown in FIG. 5.

Reaction Temperature: 873 K,

Gas Hourly Space Velocity (GHSV)=32,000 h⁻¹

Gas Composition: Propane 95% and n-Butane 5%

Steam/Carbon Molar Ratio (steam/C)=3

### Evaluation Example 2

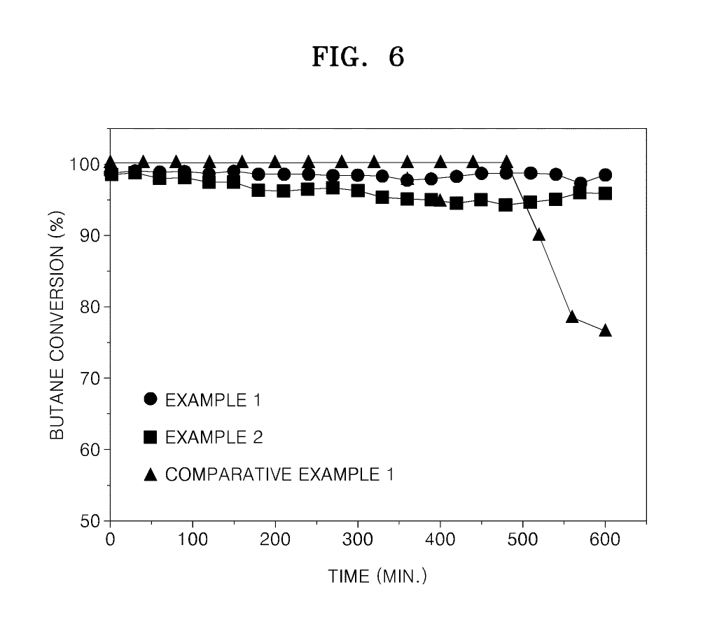

n-Butane conversions over the hydrocarbon reforming catalysts prepared in Examples 1 and 2, and Comparative Example 1 were measured over time, under the same operation conditions as Evaluation Example 1, except that n-butane was used instead of propane, and the results are shown in FIG. 6.

### Evaluation Example 3

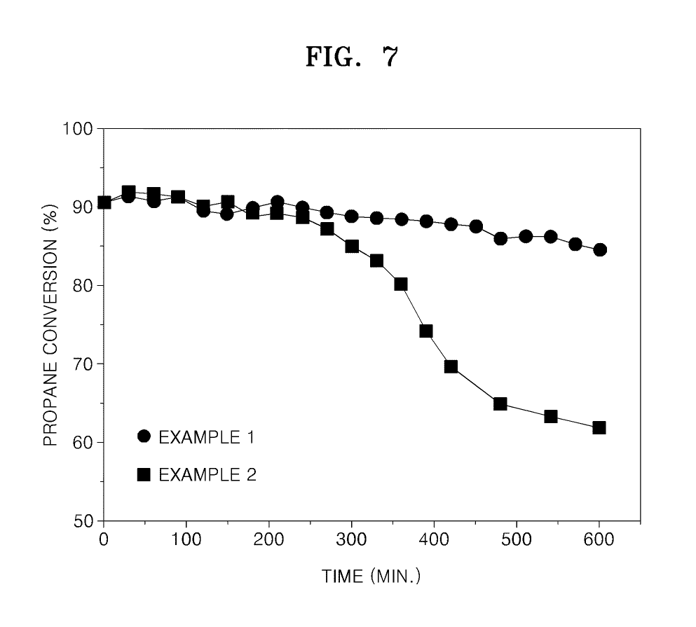

Propane conversions over the hydrocarbon reforming catalysts prepared in Examples 1 and 2, and Comparative Example 1 were measured over time, under the following operation conditions, and the results are shown in FIG. 7. Here, the hydrocarbon catalyst of Comparative Example 1 exhibited a propane conversion rate of below 80%, after initially starting a reforming reaction, but it was impossible to perform the reforming reaction after 1 to 2 hours, due to increased pressure in a reactor caused by severe carbon deposition.

Reaction Temperature: 973 K

GHSV=609,000 h⁻¹

Gas Composition: Propane 95% and n-Butane 5%

Steam/Carbon Molar Ratio (steam/C)=3

### Evaluation Example 4

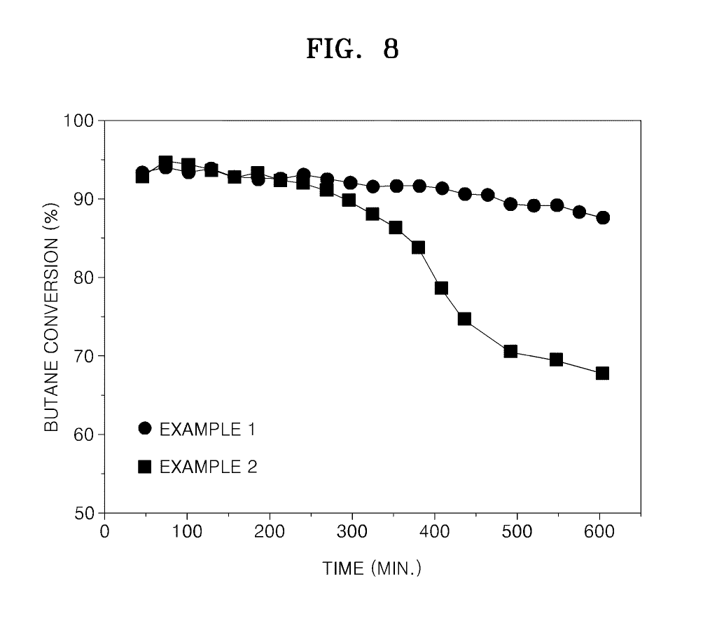

n-Butane conversions over the hydrocarbon reforming catalysts prepared in Examples 1 and 2, and Comparative Example 1 were measured over time, under the same operation conditions as Evaluation Example 3, except that n-butane was used instead of propane, and the results are shown in FIG. 8. Here, the hydrocarbon catalyst of Comparative Example 1 exhibited an n-butane conversion rate of below 85% for 1 hour, but was impossible to operate after 2 hours, due to severe carbon deposition.

### Evaluation Example 5

The hydrocarbon reforming catalysts of Examples 1 and 2, and Comparative Example 1 were operated for 10 hours, under the same operating conditions as Evaluation Example 3, the hydrocarbon reforming catalysts were collected from a reactor, and then carbon deposition ratios of the hydrocarbon reforming catalysts were measured using a thermogravimetric analysis (TGA). The carbon deposition ratios were calculated as follows.

Carbon Deposition Ratio=(Weight of Heat Loss)/(Weight of Sample)×100

The results of measuring the carbon deposition rates are shown in Table 1 below.

TABLE 1

| | TGA (Carbon |
|---|---|
| | Deposition Rate, %) |
| Example 1 | 11 |
| Example 2 | 11 |
| Comparative | 64 |
| Example 1 | |

Referring to FIGS. 5 through 8, the hydrocarbon reforming catalysts of Examples 1 and 2 had excellent reactivity, even during a long operation. Also, referring to Table 1, the carbon deposition rates of the hydrocarbon reforming catalysts of Examples 1 and 2 were low.

As described above, according to the one or more of the above exemplary embodiments, a hydrocarbon reforming catalyst having excellent coking resistance is provided.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

Although a few exemplary embodiments of the present invention have been shown and described, it would be appreciated by those skilled in the art that changes may be made in these exemplary embodiments, without departing from the principles and spirit of the present teachings, the scope of which is defined in the claims and their equivalents.

What is claimed is:

1. A hydrocarbon reforming catalyst comprising:
an oxide carrier;
a nickel active catalyst layer disposed on the oxide carrier; and
a metal oxide.

2. The hydrocarbon reforming catalyst of claim 1, wherein the metal oxide is at least one co-catalyst selected from a group consisting of a manganese oxide, a tin oxide, a cerium oxide, a rhenium oxide, a molybdenum oxide, and a tungsten oxide.

3. The hydrocarbon reforming catalyst of claim 1, wherein the oxide carrier is formed of at least one oxide selected from the group consisting of Al₂O₃, SiO₂, ZrO₂, TiO₂ and yttria-stabilized zirconia(YSZ).

4. The hydrocarbon reforming catalyst of claim 1, wherein the metal oxide is distributed on the surface of the nickel active catalyst layer.

5. The hydrocarbon reforming catalyst of claim 1, wherein the metal oxide is distributed within the nickel active catalyst layer.

6. The hydrocarbon reforming catalyst of claim 1, wherein the metal oxide is distributed on the surface of and within the nickel active catalyst layer.

7. The hydrocarbon reforming catalyst of claim 1, wherein the amount of the nickel is from about 1.0 to about 40 parts by weight based on 100 parts by weight of the hydrocarbon reforming catalyst.

8. The hydrocarbon reforming catalyst of claim 1, wherein an amount of metal of the metal oxide is from about 0.5 to about 20 parts by weight based on 1 part by weight of the nickel.

9. A method of preparing a hydrocarbon reforming catalyst, the method comprising:
loading a nickel precursor onto an oxide carrier to form a nickel precursor-loaded carrier;
heat-treating the nickel precursor-loaded carrier to form a nickel active catalyst layer;
loading a metal oxide precursor on the nickel active catalyst layer and heat-treating the resultant to form a metal oxide.

10. The method of claim 9, wherein the loading of the nickel precursor and the loading of the metal oxide precursor are performed by deposition precipitation, co-precipitation, wet impregnation, sputtering, gas-phase grafting, liquid-phase grafting, or incipient-wetness impregnation.

11. The method of claim 9, wherein the heat-treating is performed for from about 2 to about 5 hours at from about 500 to 750 about C°.

12. The method of claim 9, wherein the metal oxide is at least one co-catalyst selected from the group consisting of a manganese oxide, a tin oxide, a cerium oxide, a rhenium oxide, a molybdenum oxide, and a tungsten oxide.

13. The method of claim 9, wherein the oxide carrier is formed of at least one oxide selected from the group consisting of Al₂O₃, SiO₂, ZrO₂, TiO₂ and yttria-stabilized zirconia(YSZ).

14. A method of preparing a hydrocarbon reforming catalyst, the method comprising:
loading a metal oxide precursor on an oxide carrier to form a metal oxide precursor-loaded oxide carrier;
heat-treating the metal oxide precursor-loaded oxide carrier to form a metal oxide-loaded oxide carrier;
loading a nickel precursor on the metal oxide-loaded oxide carrier to form a resultant; and
heat-treating the resultant to form a nickel active catalyst layer.

15. A method of preparing a hydrocarbon reforming catalyst, the method comprising:
simultaneously loading a metal oxide precursor and a nickel precursor on an oxide carrier to form a resultant; and
heat-treating the resultant to form the hydrocarbon reforming catalyst.

16. A fuel cell comprising the hydrocarbon reforming catalyst according to claim 1.

17. A fuel cell comprising the hydrocarbon reforming catalyst according to claim 2.

18. A fuel cell comprising the hydrocarbon reforming catalyst according to claim 3.

19. A fuel cell comprising the hydrocarbon reforming catalyst according to claim 4.

20. A fuel cell comprising the hydrocarbon reforming catalyst according to claim 5.
